(19) United States
(12) Patent Application Publication
(10) Pub. No.: US 2025/0356346 A1
(43) Pub. Date: Nov. 20, 2025

(54) METHODS FOR PROCESSING RESOURCES IN BLOCKCHAIN, AND BLOCKCHAIN NODES

(71) Applicant: Ant Blockchain Technology (Shanghai) Co., Ltd., Shanghai (CN)

(72) Inventors: Minghao YIN, Hangzhou (CN); Dayi Yang, Hangzhou (CN); Zhiyuan Zhou, Hangzhou (CN); Liwei YUAN, Hangzhou (CN)

(73) Assignee: Ant Blockchain Technology (Shanghai) Co., Ltd., Shanghai (CN)

(21) Appl. No.: 19/279,750

(22) Filed: Jul. 24, 2025

Related U.S. Application Data
(63) Continuation of application No. PCT/CN2023/135011, filed on Nov. 29, 2023.

(30) Foreign Application Priority Data
May 31, 2023 (CN) 202310638229.7

(51) Int. Cl. G06Q 20/36; H04L 9/00

(52) U.S. Cl. CPC G06Q 20/3678; H04L 9/50

(57) ABSTRACT

Disclosed are methods for processing resources in a blockchain, and blockchain nodes. In an implementation, a method includes: receiving a transaction, wherein the transaction invokes a contract to invoke a interface provided by a blockchain platform, execute the interface based on the transaction, determining whether a resource corresponding to a first storage key is stored in a contract state of the contract, and storing a first non-fungible token (NFT) resource in the contract state in association with the first storage key if the resource corresponding to the first storage key is not stored in the contract state of the contract.

### CROSS-REFERENCE TO RELATED APPLICATIONS

This application is a continuation of PCT Application No. PCT/CN2023/135011, filed on Nov. 29, 2023, which claims priority to Chinese Patent Application No. 202310638229.7, filed on May 31, 2023, and each application is hereby incorporated by reference in its entirety.

### TECHNICAL FIELD

Embodiments of this specification belong to the field of blockchain technologies, and particularly relate to methods for processing resources in a blockchain, and blockchain nodes.

### BACKGROUND

Blockchains are a novel application model of computer technologies such as distributed data storage, peer-to-peer transmission, consensus mechanisms, and encryption algorithms. In blockchain systems, data blocks are organized into a chain data structure in chronological order, and distributed ledgers that cannot be tampered with or forged are cryptographically ensured. The blockchains have characteristics such as decentralization, tamper-resistance of information, and autonomy, and therefore the blockchains have received increasing attention and applications.

### SUMMARY

An objective of this application is to provide methods for processing resources in a blockchain, so as to improve resource security in the blockchain.

A first aspect of this specification provides methods for processing resources in a blockchain. The method is executed by a blockchain node, and includes the following steps: a first transaction is received, where the first transaction invokes a contract, the contract includes invoking of a first interface, and the first interface is provided by a blockchain platform; and the first interface is executed according to the first transaction, whether a resource corresponding to a first storage key is stored in a contract state of the contract is determined, and a first non-fungible token (NFT) resource is stored in the contract state in association with the first storage key if the resource corresponding to the first storage key is not stored in the contract state of the contract.

A second aspect of this specification provides methods for processing resources in a blockchain. The method is executed by a blockchain node, and includes the following steps: a second transaction is received, where the second transaction invokes a contract, the contract includes invoking of a second interface, and the second interface is provided by a blockchain platform; and the second interface is executed according to the second transaction, and the balance of a first resource corresponding to a third storage key in a contract state of the contract is updated.

A third aspect of this specification provides blockchain nodes. The blockchain node includes the following: a reception unit configured to receive a first transaction, where the first transaction invokes a contract, the contract includes invoking of a first interface, and the first interface is provided by a blockchain platform; and a storage unit configured to execute the first interface according to the first transaction, determine whether a resource corresponding to a first storage key is stored in a contract state of the contract, and store a first NFT resource in the contract state in association with the first storage key if the resource corresponding to the first storage key is not stored in the contract state of the contract.

A fourth aspect of this specification provides blockchain nodes. The blockchain node includes the following: a reception unit configured to receive a second transaction, where the second transaction invokes a contract, the contract includes invoking of a second interface, and the second interface is provided by a blockchain platform; and an updating unit configured to execute the second interface according to the second transaction, and update the balance of a first resource corresponding to a third storage key in a contract state of the contract.

A fifth aspect of this specification provides a computer-readable storage medium. The computer-readable storage medium stores a computer program. When the computer program is executed in a computer, the computer is caused to execute the method according to the first aspect or the second aspect.

A sixth aspect of this specification provides blockchain nodes. The blockchain node includes a memory and a processor. The memory stores executable codes. The processor executes the executable codes to implement the method according to the first aspect or the second aspect.

In the solutions provided by the embodiments of this specification, operations such as creation, transfer and deletion are performed on resources through application programming interfaces (APIs) provided by the blockchain platform, such that security problems caused by programming errors can be avoided.

### BRIEF DESCRIPTION OF THE DRAWINGS

To describe technical solutions in embodiments of this specification more clearly, the accompanying drawings for description of the embodiments will be briefly introduced below. Clearly, the accompanying drawings in the following description are merely some embodiments of this specification, and a person of ordinary skill in the art can still derive other drawings from these accompanying drawings without creative efforts.

FIG. 1 is a schematic diagram illustrating deployment of a smart contract in some embodiments;

FIG. 2 is a schematic diagram illustrating invoking of a smart contract in some embodiments;

FIG. 3 is a schematic diagram illustrating a data storage structure of a blockchain in some embodiments;

FIG. 4 is a schematic diagram illustrating a data storage structure of a blockchain in some embodiments;

FIG. 5 is a schematic diagram illustrating a slot structure in some embodiments;

FIG. 6 is a schematic diagram illustrating operations for slots;

FIG. 7 is a flowchart illustrating a method for processing non-fungible token (NFT) resources in embodiments of this specification;

FIG. 8 is a flowchart illustrating a method for processing resources in embodiments of this specification;

FIG. 9 is a schematic diagram illustrating state data of a resource object of a numeric type in embodiments of this specification;

FIG. 10 is a structural diagram illustrating a blockchain node in embodiments of this specification; and

FIG. 11 is a structural diagram illustrating a blockchain node in embodiments of this specification.

### DETAILED DESCRIPTION OF THE EMBODIMENTS

In order to enable a person skilled in the art to better understand technical solutions in this specification, the technical solutions in embodiments of this specification will be clearly and completely described in combination with the accompanying drawings in the embodiments of this specification. Clearly, the described embodiments are merely some embodiments rather than all embodiments of this specification. All other embodiments obtained by a person of ordinary skill in the art based on the embodiments of this specification without creative efforts should fall within the protection scope of this specification.

Blockchains are generally classified into three types: public blockchains, private blockchains, and consortium blockchains. In addition, there are combinations of a plurality of types, such as combinations of private blockchains and consortium blockchains, and combinations of consortium blockchains and public blockchains. The public blockchains have the highest degree of decentralization. Ethereum is an example of public blockchains. Participants that join the public blockchains can read data records in the blockchains, participate in transactions, contend for ledger permission of new blocks, etc. In addition, each of the participants (embodied as nodes of the participants in the blockchains) can freely join and exit networks and perform related operations. The private blockchains are opposites of the public blockchains. Writing permission of the networks is controlled by an organization or an institution, and data reading permission is specified by the organization. In short, the private blockchain can be a weakly centralized system, and has less participating nodes with strict restrictions. This type of blockchains are more suitable for internal use of specific institutions. The consortium blockchains vary from the public blockchains to the private blockchains, and can implement “partial decentralization”. Each of the nodes in the consortium blockchains generally has a corresponding entity institution or organization. Participants are authorized to join the networks and constitute a stakeholder alliance, and jointly maintain running of the blockchains.

Most of the public blockchains, the private blockchains and the consortium blockchains can provide a function of smart contracts. The smart contracts in the blockchains are contracts whose execution can be triggered by transactions in a blockchain system. The smart contracts can be defined in a form of codes.

With the Ethereum as an example, users are supported to create and invoke some complex logics in an Ethereum network. The Ethereum is a programmable blockchain, and a core of Ethereum is an Ethereum virtual machine (EVM). Each Ethereum node can run the EVM. The EVM is a Turing-complete virtual machine, which means that various complex logics can be implemented through the EVM. Deploying and invoking smart contracts in the Ethereum by the users are implemented by the EVM. In fact, the virtual machine directly runs virtual machine codes (virtual machine bytecodes, referred to as “bytecodes” below). The smart contracts deployed on the blockchains can be in a form of bytecodes.

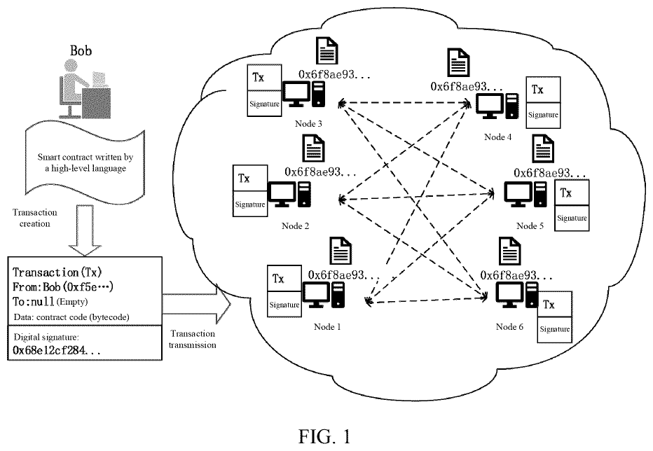

For example, as shown in FIG. 1, after Bob transmits a transaction that includes information for creating smart contracts to the Ethereum network, an EVM of node 1 can execute the transaction and generate a corresponding contract example. “0x6f8ae93 . . . ” in FIG. 1 represents an address of the contract, a data field of the transaction can store bytecodes, and a field of the transaction is an empty account. After nodes reach an agreement through consensus mechanisms, the contract is successfully deployed, and then the users can invoke the contract.

After the contract is successfully deployed, a contract account corresponding to the smart contract appears in the blockchains and has a specific address. Contract codes and account storage are stored in the contract account. Behaviors of the smart contracts are controlled by contract codes, while account storage of the smart contracts stores states of contracts. In other words, the smart contracts enable a virtual account including the contract codes and the account storage to be generated on the blockchain.

As mentioned above, the data field of the transaction including creation of the smart contract can include bytecodes of the smart contract. The bytecodes include a series of bytes, and each of the bytes can identify an operation. Considering development efficiency, readability, etc., developers can choose a high-level language to write smart contract codes instead of writing bytecodes directly. The smart contract codes written in the high-level language are compiled by compilers, bytecodes are generated, and then the bytecodes can be deployed in the blockchains. The Ethereum supports many high-level languages, such as Solidity, Serpent, and Low-Level Lisp-like (LLL) Language.

With Solidity as an example, contracts written in Solidity are similar to classes in object-oriented programming languages. A plurality of members (or objects) can be stated in a contract, and include state variables, functions, function modifiers, events, etc. The state variables are values permanently stored in the account storage of the smart contracts, and are used to keep the states of the contracts.

Code example 1 of a simple smart contract written in Solidity is as follows:

| | |
|---|---|
| 1 | Contract SimpleStorage { |
| 2 | string storedData; |
| 3 | event stored(address from, string s) |
| 4 | function set(string s) { |
| 5 | storedData = s; |
| 6 | stored(msg.sender, s); |
| 7 | } |
| 8 | function get( ) constant returns (string) { |
| 9 | return storedData; |
| 10 | } |
| 11 | } |

### Code Example 1, SimpleStorage Codes

In the above-mentioned code example 1, a state variable storedData of a character type of a string is stated in line 2, and an event is stated in line 3. The event stores an address of an initiator invoking the contract and the string s. Lines 4-7 define a set function, and input parameters are strings s. Operations executed by the set function include setting the input parameters to the state variable storedData, and generating an event. Contents of the event include the address of the initiator invoking the contract and the string s.

As mentioned above, the state variables are eventually stored in a database. Lines 8-10 define a get function. Operations of the function include returning an inquired value of storedData, returns (string) indicate types of return values, and constant modifiers indicate that the function cannot modify values of the state variables in the contract.

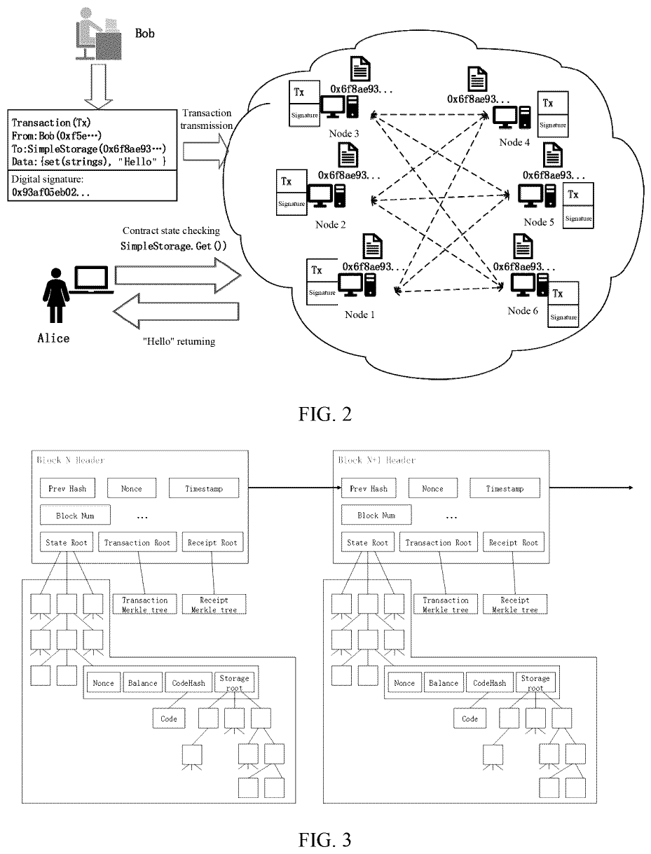

In addition, as shown in FIG. 2, still with the Ethereum as an example, after Bob transmits a transaction that includes information for invoking smart contracts to the Ethereum network, an EVM of node 1 can execute the transaction and generate a corresponding contract example. From fields of transactions in FIG. 2 are addresses of accounts that initiate invoking of the smart contracts, “0x6f8ae93 . . . ” in to fields represents an address of the invoked smart contract, and data fields of transactions store methods and parameters for invoking the smart contracts. After the smart contracts are invoked, the value of storedData may be changed. Then, a certain client device can check a current value of storedData through a certain blockchain node (for example, node 6 in FIG. 2).

The smart contract can be executed independently by each node in a blockchain network in a specified way, and all execution records and data are stored on the blockchain. Thus, when such transactions are completed, transaction vouchers that cannot be tampered with and cannot be lost are stored on the blockchain.

As mentioned above, storedData in the above-mentioned examples is the state variable, and is stored in the account storage of the smart contracts. In various blockchain networks that introduce the smart contracts, with the Ethereum as an example, accounts can generally include two types: contract accounts that store executed smart contract codes and values of states in the smart contract codes, which can merely be invoked and activated through externally owned accounts; and externally owned accounts that are accounts of users.

Designs of the externally owned accounts and the contract accounts are actually mapping of account addresses to account states. The account states generally include fields such as Nonce, Balance, Storage root, and CodeHash. The Nonce and the Balance exist in both the externally owned accounts and the contract accounts. The CodeHash and Storage root attributes are generally merely valid on the contract accounts.

The Nonce indicates a counter. For the externally owned accounts, the number can represent the number of transactions transmitted from the account addresses. For the contract accounts, the number can be the number of contracts created by accounts.

The Balance indicates the account balance.

The Storage root is a hash of a root node of a Merkle Patricia tree (MPT). The MPT organizes storage of state variables of the contract accounts.

The CodeHash is a hash value of the smart contract codes. For the contract accounts, the CodeHash is a hash value of the smart contracts. For the externally owned accounts, the smart contracts are not included, so CodeHash fields can generally be empty strings/all-0 strings.

A full name of the MPT is the Merkle Patricia Tree, which is a tree structure that combines the Merkle Tree and the Patricia Tree (a compressed prefix tree that is a more space-saving trie). A Merkle Tree algorithm computes a hash value for each transaction, and then computes Hash by connecting every two hash values, until a top Merkle root is reached. An improved MPT, for example, a structure of a 16-branch tree, is used in the Ethereum, which is generally referred to as the MPT for short.

A data structure of an Ethereum MPT includes a state trie. The state trie includes a key and value pair (also referred to as a key-value, or k-v or kv for short) of a storage content corresponding to each account in the Ethereum network. The “key” in the state trie can be a 160-bits identifier (for example, an address of an Ethereum account or part of a hash value of an address, hereinafter collectively referred to as the account address), and the account address is distributed in storage from a root node to a leaf node of the state trie. The “value” in the state trie is generated by encoding information of the Ethereum account (through a recursive-length prefix encoding (RLP) method). As mentioned above, for the externally owned accounts, values include nonce and balance. For the contract accounts, values include nonce, balance, codehash, and storageroot.

The contract accounts are used to store states related to the smart contracts. After the smart contract is deployed on the blockchain, a corresponding contract account can be generated. This contract account can generally have some states. The states are defined by the state variables in the smart contracts and generate new values when the smart contracts are executed. The smart contracts generally refer to contracts defined in a code form in a blockchain environment and capable of automatically executing terms. Once an event triggers terms in the contract (satisfies execution conditions), codes can be automatically executed. In the blockchain, relevant states of the contract are stored in a storage trie, and a hash value of a root node of the storage trie is stored in above-mentioned storageroot, such that all the states of the contract are locked to the contract account through hash. The storage trie is also a MPT tree structure, and stores key-value mapping from state addresses to state values. Part of information from the root node to a leaf node of the storage trie is sequentially arranged to store an address of a state. The leaf node stores a value of the state.

In some blockchain data storage shown in FIG. 3, a block header of each block includes several fields, and for example, a previous block hash previous_Hash (Prev Hash in the figure), a random number Nonce (the Nonce is not a random number in some blockchain systems, or the nonce in the block header is not enabled in some blockchain systems), a time stamp Timestamp, a block number Block Num, a state root hash State_Root, a transaction root hash Transaction_Root, and a receipt root hash Receipt_Root. Prev Hash in a block header of a next block (for example, a block N+1) points to a previous block (for example, a block N), that is, a hash value of the previous block. In this way, an effect of locking the previous block by a next block is achieved in the blockchain through the block header. The State_Root, the Transaction_Root and the Receipt_Root lock a state set, a transaction set and a receipt set, respectively. The state set, the transaction set and the receipt set organize states, transactions and receipts in a form of trees, respectively. Generally, they can be of the same tree structure, or different tree structures. For example, in the Ethereum, the same MPT structure is used. Some tree structures, such as the Ethereum, including state sets of the smart contracts, include MPT structures of two levels: leaf nodes of a previous-level MPT structure have two types of externally owned accounts and contract accounts; each of the contract accounts includes a next-level MPT structure, and leaf nodes of a next level include values of states in the contract accounts.

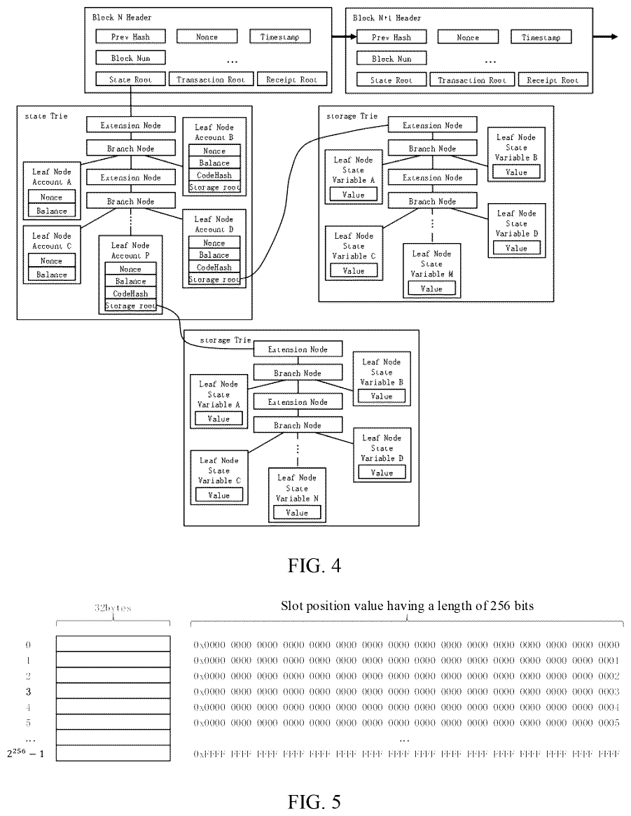

FIG. 4 is a schematic structural diagram illustrating data storage of a blockchain. Still with the Ethereum as an example, it can be seen in FIG. 3 that state_root is a hash value of a root of an MPT including states of all accounts in a current block, that is, a state trie in a form of an MPT points to the state_root. A root node of the MPT is generally an extension node or a branch node, and a hash value of the root node is generally stored in the state_root. The root node can be connected to one or more layers of extension nodes/branch nodes below, and the layers of tree nodes can be collectively referred to as internal nodes. Some values from the root node to each node in leaf nodes of the MPT can be connected in series sequentially so as to constitute an account address and serve as a key, and account information stored in the leaf nodes is a value corresponding to the account address. Thus, a key-value pair is formed. The key can also be a part taken after sha3 (Address), that is, part of a hash value of the account address (for example, a sha3 algorithm is used as a hash algorithm), and a stored value can be rlp (Account), that is, an rlp code of the account information. The account information is a quaternion of [nonce,balance,storageRoot,codeHash]. As mentioned above, for an externally owned account, there are generally only two items: nonce and balance, and storageRoot and codeHash fields store empty strings/all-0 strings by default. That is, the externally owned accounts store no contracts, and store no state variables generated after contracts are executed. Contract accounts generally include Nonce, Balance, Storage root, and CodeHash. The Nonce is a transaction counter of the contract account. The Balance is the account balance. The Storage root corresponds to another MPT, and can be linked to contract-related state information through the Storage root. The CodeHash is a hash value of a contract code. Account information of an externally owned account or a contract account is generally located in a separate leaf node. From an extension node/branch node of the root node to a leaf node of each account, several branch nodes and extension nodes may be passed.

The state trie can be a tree in a form of MPT, and generally a 16-branch tree. That is, each layer can have up to 16 child nodes. The extension node is used to store common prefixes, and generally has 1 child node. The child node can be a branch node. The branch node can have up to 16 child nodes, which may include an extension node and/or a leaf node.

For a contract account in the state trie, its storage_Root points to another tree in a form of MPT, and stores data of state variables involved in contract execution. The tree, pointed by the storage_Root, in a form of MPT is a storage trie, which is a hash value of a root node of the storage trie. Generally, the storage trie also stores key-value pairs. The key indicates an address of the state variable, and a value of the key can be a result obtained by processing a stated position of the state variable (a value counted from 0) in the contract according to certain rules, such as sha3 (a stated position of the state variable), or sha3 (a contract name+a stated position of the state variable). The value is used to store a value of the state variable (such as an RLP-encoded value). Some data stored on a path from the root node to the leaf nodes through an internal node are connected to constitute the key, and the leaf nodes store the value. As mentioned above, the storage trie can be a tree in a form of MPT, and generally a 16-branch tree. That is, the branch node may have up to 16 child nodes. The child nodes may include an extension node and/or a leaf node. The extension node can generally have 1 child node. The child node can be a branch node or a leaf node.

For example, Leaf Node Account P of the state trie in FIG. 4 is a contract account, and its storage root locks all states in the contract storage. The states are organized to form a MPT, and a tree structure is like a storage trie linked by the storage root. In the linked storage trie, for example, if Leaf Node State Variable N is a value of the storedData in the example of the contract code, its key can be, but is not limited to, sha 3 (the stated position of the storedData), and its value is s (for brevity, an encoding format of the value is omitted herein, such as RLP, and the following contents are shown in a similar way and will not be repeated herein). Values of the key are sequentially distributed from the root node to the leaf nodes (that is, Leaf Node Variable N) of the storage trie.

For example, Leaf Node Account C in the state trie in FIG. 4 is an externally owned account, its key is sha3 (Address C), that is, a hash value of an address of the account C (for example, a sha3 algorithm is used as a hash algorithm), and its stored value can be (Account). Account information Account is a binary group of [nonce,balance]. As mentioned above, Account C is an externally owned account, so its account information includes nonce and balance (codehash and storage root are not included herein, and the following contents are shown in a similar way). For example, if an externally owned account has nonce of 20 and Balance of 4550, a leaf node of Leaf Node State Variable C stores nonce=20 and balance=4550. An address of Account C is a key, and values of the key are sequentially distributed from the root node to the leaf node (that is, Leaf Node Variable C) of the state trie.

It can be understood that a data structure of state data in the embodiments of this specification is not limited to that shown in FIG. 4, and can be another data structure.

As mentioned above, after the transaction for creating a smart contract is transmitted to the blockchain and a consensus about the transaction is reached in the blockchain, each node of the blockchain can execute the transaction. In this case, a contract account corresponding to the smart contract appears on the blockchain (which includes an identifier of the account, a hash value Codehash of the contract, and a root StorageRoot of contract storage for example), and has a specific address. The contract code and the account storage can be stored in storage of the contract account. Behaviors of the smart contracts are controlled by the contract codes, and the account storage of the smart contracts stores the states of the contract. In other words, the smart contracts enable a virtual account including the contract codes and the account storage to be generated on the blockchain. For a contract deployment transaction or a contract update transaction, a value of Codehash can be generated or changed. Subsequently, the blockchain node can receive a transaction request invoking the deployed smart contract. The transaction request can include an address of the invoked contract, a function in the invoked contract, and input parameters. Generally, after the transaction request reaches a consensus, each node of the blockchain can independently execute the specially invoked smart contract.

When the blockchain node executes the transaction invoking the contract, the virtual machine in the node loads and executes the contract bytecodes, and states may be generated and/or read, such that the underlying database needs to be accessed. The virtual machine needs to conveniently access an underlying key value (KV) database. Generally, an ability of accessing data similar to a pointer can be used to access the KV database. For example, in the Ethereum, if a value corresponding to a key needs to be read from the KV database, a key of the data needs to be known before access.

Each contract generally has its own virtual storage space. Capacity of the virtual storage space can be a very large array, such as an array with 2²⁵⁶ elements numbered from 0 to 2²⁵⁶−1. Each element can occupy a certain length, and for example, 32 bytes. Each element is referred to as a slot herein. FIG. 5 is a schematic diagram illustrating a slot structure in some embodiments. It should be noted that a total storage space of 2²⁵⁶ slots is total capacity of a virtual space. That is, unused slots do not occupy an actual storage space of the underlying database.

When the virtual machine executes the contract bytecodes, a slot position of the same state variable in the virtual storage space needs to be fixed, such that the key generated by contract execution can be fixed generally after contract codes are determined. Thus, fixation of the position of the state variable is generally decided during compilation of the compiler, which is not directly related to the virtual machine.

A compiling process of the compiler can roughly include the following steps: an abstract syntax tree is generated, lexical/grammatical analysis is performed according to the abstract syntax tree, symbols are applied according to a symbol table, and semantic analysis and code generation are performed. The abstract syntax tree includes a plurality of nodes arranged sequentially. The plurality of nodes correspond to a plurality of objects stated in the contract. An arrangement order of the plurality of nodes corresponds to stated positions of the plurality of objects in the contract. The plurality of objects include first state variables. In the process of lexical/grammatical analysis according to the abstract syntax tree, slot position information of the state variables of the contract can be generated. Assuming that codes of contract C1 are as follows:

```
Contract C1 {
  unit256 A;
bool B;
//mapping from token ID to owner
mappping(uint256 => address) Map1
//mapping from owner to number of owned token
mappping(uint256 => Counter) Map3
  function setA(uint256 x) public {
      A = x;
  }
  function getA( ) public view returns(unit256) {
      return A;
  }
  function setB(bool t) public {
      B= t;
  }
  function getB( ) public view returns(bool) {
      return B;
  }
  pub mint1(holder,data) {
    Map1[holder].Pmint1(Map1,holder, Account-C1,data)
}
  pub mint2(holder,data,value) {
    Map3[holder].Pmint2(Map3,holder,Account-C1,value);
    Map3[holder].store{Map3,holder, Account-C1,data}
}
...
}
Code example 2, Solidity Codes of Contract C1
```

According to the contract codes, for example, an abstract syntax tree is generated as follows: in the abstract syntax tree, information related to an object is put into a node. The objects include, for example, state variables A and B, and mapping relationships “Map1” and “Map3”. A plurality of nodes corresponding to a plurality of objects are arranged in order stated by each object in the contract. For example, a 0^{th} node in the abstract syntax tree corresponds to the state variable A, a 1^{st} node in the abstract syntax tree corresponds to the state variable B, a 2^{nd} node in the abstract syntax tree corresponds to the mapping relationship Map1, and a 3^{rd} node in the abstract syntax tree corresponds to the mapping relationship Map3. Each node includes several pieces of information. On the whole, information in a node can be referred to as node information of the abstract syntax tree.

For the abstract syntax tree of the contract C1, node positions of the 2 state variables A and B in the contract C1 in the abstract syntax tree are 0 and 1 respectively, and can correspond to slots at 2 positions in FIG. 5 as follows:

```
  0x0000 0000 0000 0000 0000 0000 0000 0000 0000 0000 0000 0000
0000 0000 0000 0000
  0x0000 0000 0000 0000 0000 0000 0000 0000 0000 0000 0000 0000
0000 0000 0000 0001
```

The positions of the 2 slots are each 256 bits, and are 32 bytes in hexadecimal (0x). 4 consecutive hexadecimal digits in each segment separated by spaces after the 0x represent 2 bytes, so there are 16 such segments in total.

In this way, in the contract bytecodes compiled by the compiler, the 2 positions of slots can be used to replace identifiers of 2 state variables. For example, the above-mentioned 256 bits and 256 bits replace A and B respectively. In this way, when a data type is a fixed value, a storage position can be pre-allocated to each of data that are to be stored in order by fields during compilation, which is equivalent to specifying a fixed data pointer in advance.

In a process of loading and executing the contract bytecodes by the virtual machine, an operation for A is an operation for a slot position corresponding to 0x000 . . . 00 (that is, the above-mentioned slot position 0, where more 0s are replaced by ellipsis). Similarly, an operation for B is an operation for the slot position of 0x000 . . . 01.

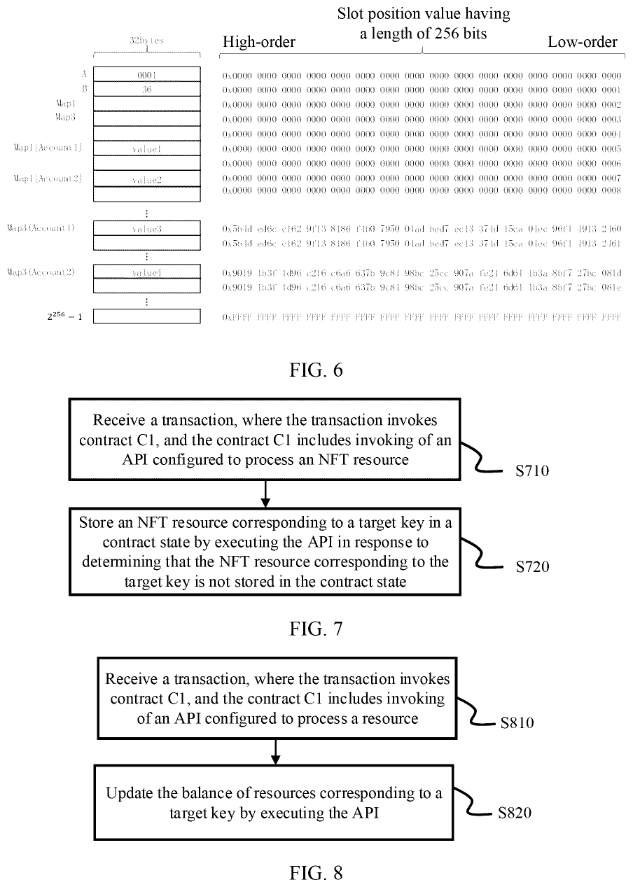

FIG. 6 is a schematic diagram illustrating operations for slots. As shown in FIG. 6, for example, if a transaction invoking contract C1 invokes a setA ( ) function in the contract and an input parameter is a string “0001”, a virtual machine stores the slot position of a 0x000 . . . 01 as 0001 in a process of executing the transaction. Specifically, the virtual machine can push the 32-byte slot of 0x000 . . . 01 into a stack, and then push a corresponding value into the stack. In a process of interpreting execution, OPcode of an invoked function is obtained from a memory and starts to be executed. According to first-in-last-out or last-in-first-out characteristics of the stack, the value is popped up from the stack, and then the slot is popped up from the stack, such that a slot-value pair is formed. Then, a contract virtual machine executes current opcode, that is, writes the value into storage at a slot position. It can be seen that the slot is equivalent to a number, and can be used to uniquely identify state variables of the contract during contract execution. In the above-mentioned process, the stack generally uses 32 bytes as a storage unit, which is equal to a length of 1 slot. If the corresponding value may be less than, equal to or greater than 32 bytes, the value may occupy 1 unit or more units in the stack.

Further, as shown in FIG. 6, for example, if a transaction invoking contract C1 invokes a setB ( ) function in the contract and an input parameter is “36”, the virtual machine stores the slot 0x000 . . . 02 as 36 in a process of executing the transaction.

Results generated by execution of the above-mentioned two contracts can be simply expressed as follows:

$$0 \times 000 … 00 : 0001 \qquad ( 1 )$$

$$0 \times 000 … 01 : 36 \qquad ( 2 )$$

After the virtual machine completes execution, the virtual machine or a blockchain platform can convert slots in the 2 slot-value key-value pairs (1) and (2) into state keys. Specifically, the state key (that is, a storage key of a state variable in a storage trie) can be obtained by splicing a contract address and a slot position. For example, an address length of the contract C1 is 20 bytes, that is, 0x3321 dcaf 8911 d384 2e14 a7a4 15be 2fb1 a337 f43e. After the contract address and the slot position are spliced,

(1) the state key of the corresponding state variable A is:

0x3321dcaf8911d3842e14a7a415be2fb1a337f43e0000000000000000000000000000
000000000000000000000000000000000000

(2) the state key of the corresponding state variable B is:

0x3321dcaf8911d3842e14a7a415be2fb1a337f43e0000000000000000000000000000
000000000000000000000000000000000001

Then, a blockchain node can store generated state key-values in an underlying database. Specifically, the blockchain node can include a tree creation module and a state database module. The tree creation module can transform the keys into the storage trie as shown in FIG. 4, and build values in the state key-values into a leaf node of the MPT. It should be noted that, as mentioned above, the state key is divided into several small segments, which are sequentially stored in tree nodes from a root to leaf nodes of the storage trie. Which segment of a state key is stored in each tree node depends on a common prefix between the state key and other state keys in the tree. From the leaf node to an internal node and then to a root node, a series of hash value changes can be caused, and the tree creation module can build kvs of the tree nodes. Further, the tree creation module transmits the changed kvs of the tree nodes to the state database module, and finally the state database module stores the kvs in a state database.

In the above-mentioned process, slots of the state variables are fixed in a compilation process, and are determined according to contract addresses and slot positions of the state variables as mentioned above. The state keys can be obtained by splicing the contract addresses and the slots. In this way, in a case of running the same contract, if the same state variables are read and written, the same slot can be used, which corresponds to a fixed state key.

It should be noted that types of the state variables A and B in the above-mentioned examples are uint256 and bool respectively, where the uint256 is 256 bits, that is, 32 bytes, and the bool type is 1 byte. The types of the state variables determine that a length of data is fixed, or data are fixed-length. In addition, types such as uint, uint8 and uint128 are also fixed-length. A certain number of arrays composed of fixed-length elements are also fixed-length. For example, uint[2] includes 2 elements, and each of the elements is of a uint type of 32 bytes, so the whole uint[2] is 64 bytes.

In addition to fixed-length data storage, variable-length data storage exists, or a data size is unpredictable. In this case, the slot position cannot be determined directly during compilation through a fixed-length method, and a different solution is used.

For example, in the contract C1, mappping(uint256=>address) Map1 and mappping(uint256=>Counter) Map3 are defined after the state variables A and B, that is, mapping relationships. The mapping relationships are data types having a unfixed length. With the mappping(uint256=>address) Map1 as an example, Map1 is a name of the mapping relationship.

For example, a mint1 function in the contract C1 is used to create a non-fungible token (NFT) resource. Its input parameter holder is a recipient account address of the created NFT resource, and data are resource data of the created NFT resource, and include, for example, a resource identifier of the NFT resource. In a mint1 function, resource information (data) is set for an NFT resource corresponding to Map1[holder] through a Pmint1 ( ) interface provided by the blockchain platform in the embodiments of this specification. With the Map1[holder] as an example, holder can be referred to as a key of the mapping relationship Map1.

For example, a mint2 function in the contract C1 is used to create an accumulative resource in the blockchain. The resource includes, for example, integrals, scores, grades, etc. Its input parameter holder is a recipient account address of the created resource, data are resource data of the created resource, and include, for example, resource identifiers, etc., and a value is a resource share. In the mint2 function, resource shares are set for a resource corresponding to Map3[holder] through a Pmint2 ( ) interface provided by the blockchain platform in the embodiments of this specification. Meanwhile, other information (that is, data) of the resource can be stored by the contract.

As shown in FIG. 6, when contract codes are compiled, a slot of 0x000 . . . 02 can be allocated to a name Map1 of the mapping relationship according to a position (a 2^{nd} position) of a node corresponding to the mapping relationship Map1 in the abstract syntax tree. The Map1 is not a state variable, so no value exists in the slot. Similarly, a slot having a position value of 0x000 . . . 03 can be allocated to the mapping relationship Map3.

When the virtual machine executes the contract C1, a slot of a mapping element corresponding to a key can be uniquely determined according to the key of a mapping relationship and a slot of a name of the mapping relationship. For example, the slot is keccak256(key.slot), where “.” is a splicing symbol, and a slot after “.” is a position of the slot where the name of the mapping relationship is located. The number of the mapping elements in the mapping relationships is uncertain, and lengths of keys and values in the elements are uncertain. For example, after the contract C1 is invoked several times, there may be 2 elements of the mapping relationship Map1, that is,

$$Map 1 [ Account 1 ] = value 1$$

$$Map 1 [ Account 2 ] = value 2$$

A slot position of the corresponding mapping element Map1[Account1] can be keccak256(Account1.0x000 . . . 02), and the value (for example, a data length of the value is greater than 32 bytes) can be stored in one or more consecutive slots at the beginning of the position. Similarly, a slot position of a 2^{nd} mapping element Map1[Account2] in the mapping relationship Map1 can be keccak256(Account2.0x000 . . . 02), and value2 can be stored in one or more consecutive slots at the beginning of the position.

As shown in FIG. 6, for example, a length of a value of the Map1[Account1] is less than 32 bytes, and the value (that is, value1 in FIG. 6) can be stored in 1 slot. A position of the slot is, for example, a value of keccak256(Account1,0x000 . . . 02), and for example:

$$0 \times 000 … 05$$

Similarly, for example, value2 of the Map1[Account2] can be stored in a slot corresponding to 0x000 . . . 07.

Similarly, when the virtual machine executes the contract C1, a slot of each element can be uniquely determined according to a key of the mapping element Map3[holder] and a slot of the mapping relationship Map3, that is, keccak256(holder.0x000 . . . 03). For example, as shown in FIG. 6, a slot of Map3[Account1] can be determined as follows:
0x5b4d ed6c c162 9f13 8186 f4b0 7950 04ad bed7 ec13 374d 15ca 04ec 96f1 4913 2460

A slot of Map3[Account2] can be determined as follows:
0x9019 1b3f 1d96 c216 c6a6 637b 9c84 98bc 25cc 907a fe24 6d61 1b3a 8bf7 27bc 081d

That is, for a contract including a mapping relationship, after a transaction invokes the contract and defines a mapping element, a slot of a mapping element can be uniquely determined according to a key of the mapping element in the transaction and a slot of the mapping relationship. After the slot of the mapping element is determined, a storage key of the mapping element can be obtained by splicing the contract address and the slot in the same way.

It can be understood that the above description describes how to determine the storage key of the state variable in the contract state (for example, the storage trie shown in FIG. 4) by taking the slot as an example, and does not limit this specification. In some implementations, storage keys of state variables can be determined based on contract addresses and variable names. For example, for the above-mentioned variable A, the storage key can be determined as hash (contract address.A), and for the above-mentioned variable Map1[Account1] based on the mapping relationship, the storage key can be determined as hash (contract address.Map1.Account1). In some implementations, for resource-based variables, storage variables can be determined based on resource types. For example, if a type of the NFT resource is set as 0 and a type of a cumulative resource is set as 1, the storage key of the Map1[Account1] can be determined as hash (contract address.Map1.Account1.0).

With reference to the above description, the blockchain can generate a large number of resources through smart contracts. However, most smart contracts have loopholes, and have a high risk of being attacked, such that security of resources in the blockchain declines. In view of that, the embodiments of this specification provide solutions for processing resources, where operations such as creation, transfer and deletion are performed on resources through application programming interfaces (APIs) provided by the blockchain platform, such that security problems caused by programming errors can be avoided.

The solutions for processing resources according to the embodiments of this specification will be described below with NFT resources and integral resources as examples.

FIG. 7 is a flowchart illustrating a method for processing NFT resources in embodiments of this specification. The method can be executed by blockchain nodes.

In S710, the blockchain node receives a transaction, and the transaction invokes contract C1. The contract C1 includes invoking of an API configured to process an NFT resource.

In some implementations, a user can transmit transaction Tx1 used to create an NFT resource to a blockchain. For example, the transaction Tx1 invokes a mint1 function in the above-mentioned contract C1 (with reference to the above-mentioned code example 2). The transaction Tx1 includes input parameters of the mint1 function, such as “Account1,Data1”. Account1 is a holder of the NFT resource that is to be created and specified by the user. Data1 is resource data of the NFT resource that is to be created. The resource data include, for example, a name of the NFT resource, a media content, etc.

As shown in the above-mentioned code example 2, in the function mint1, a state variable corresponding to an NFT that is to be created is set as Map1[holder], and API Pmint1( ) provided by a blockchain platform is invoked. The resource data of the NFT resource that is to be created are stored through the Pmint1( ). Input data into the interface Pmint1( ) include Map1, Account1, Account-C1, and data1. The Account-C1 is a contract address of the contract C1. The Map1, the Account1 and the Account-C1 are used to compute a storage key of the NFT resource that is to be created in a contract state of the contract C1. The Map1 can be a name of a mapping relationship or an identifier of a mapping relationship (for example, a slot corresponding to the mapping relationship).

In some implementations, the user can transmit transaction Tx2 used to transfer an NFT resource to the blockchain. For example, the transaction Tx2 invokes a transfer1 function included in the contract C1. The transaction Tx2 includes input parameters “Account1,Account2” into the transfer1 function. Account1 is an account having the NFT resource. Account2 is an account that is to receive the NFT resource.

The function transfer1 includes, for example, “Ptransfer1(Map1,Account1,Map2,Account2, Account-C1)”. Map1, Account1 and Account-C1 are used to compute a storage key of a state variable of an NFT resource that is to be transferred out. Map2, Account2 and Account-C1 are used to compute a storage key of a state variable of an NFT resource that is to be received. Ptransfer1( ) is an API provided by the blockchain platform, and the NFT resource is transferred through the Ptransfer1( ).

It can be understood that, in the embodiments of this specification, the storage key corresponding to the NFT resource is determined through the mapping relationship, which does not limit this specification. The storage key corresponding to the NFT resource can be determined in other known ways.

In S720, the blockchain node stores an NFT resource corresponding to a target storage key in the contract state by executing the API in response to determining that the NFT resource corresponding to the target storage key is not stored in the contract state.

For the above-mentioned transaction Tx1, after the blockchain node starts to execute the transaction Tx1, the Pmint1( ) is executed according to invoking of the interface Pmint1( ) in the transaction Tx1. Specifically, a virtual machine in the blockchain node uses Map1, Account1, Account-C1 and Data1 as input parameters of the interface Pmint1( ) to execute the interface Pmint1( ). In a process of executing the interface Pmint1( ), the virtual machine determines a storage key key1 (that is, a storage key of the variable Map1[Account1]) of the NFT resource that is to be created based on the Map1, the Account1 and the Account-C1 according to codes in the interface Pmint1( ). Reference can be made to above description for determination of the storage key, which will not be repeated herein. Then, the virtual machine determines whether a resource corresponding to the key1 is stored in the contract state of the contract C1 based on the key1 (the resource can include the NFT resource or integrals). If the virtual machine determines that the resource corresponding to the key1 is not stored in the contract state of the contract C1, Data1 can be stored corresponding to the key1 in the contract state of the contract C1, such that creation of the NFT resource can be completed. If the virtual machine determines that the resource corresponding to the key1 is stored in the contract state of the contract C1, execution of the transaction Tx1 can be ended, and a transaction execution failure can be returned.

By executing the interface Pmint1( ), the blockchain node can store the resource data of the NFT resource in the contract state after determining that the resource corresponding to the key1 is not stored in the contract state, such that risks such as excessive/repeated transmission can be avoided.

For the above-mentioned transaction Tx2, after the blockchain node starts to execute the transaction Tx2, the Ptransfer1( ) is executed according to invoking of the interface Ptransfer1( ) in the transaction Tx2. Specifically, the virtual machine in the blockchain node uses Map1, Account1, Map2, Account2 and Account-C1 as input parameters of the interface Ptransfer1( ) to execute the interface Ptransfer1( ). In a process of executing the interface Ptransfer1( ), the virtual machine determines the storage key key1 (that is, the storage key of the variable Map1[Account1]) currently corresponding to the NFT resource and a storage key key2 (that is, a storage key of variable Map2[Account2]) corresponding to the NFT resource after transfer based on the Map1 and the Account1 according to codes in the interface Ptransfer1( ). Then, the virtual machine determines whether a resource corresponding to the key2 is stored in the contract state of the contract C1 based on the key2 (the resource can include the NFT resource or integrals). If the virtual machine determines that the resource corresponding to the key2 is not stored in the contract state of the contract C1, Data1 stored corresponding to the key1 can be read from the contract state of the contract C1, the Data1 stored corresponding to the key1 can be deleted, and Data1 can be stored corresponding to the key2. Thus, transfer of the NFT resource is completed.

In some implementations, the input parameters of the virtual machine into the interface Ptransfer1( ) further include a resource type (for example, an NFT type) corresponding to the variable Map1 [Account1] and a resource type corresponding to the variable Map2 [Account2]. The virtual machine performs the above-mentioned transfer operation of the NFT resource after determining that the resource type corresponding to the variable Map1 [Account2] is consistent with the resource type corresponding to the variable Map2 [Account1].

FIG. 8 is a flowchart illustrating a method for processing resources in embodiments of this specification. The method can be executed by blockchain nodes.

As shown in FIG. 8, in S810, the blockchain node receives a transaction, and the transaction invokes contract C1. The contract C1 includes invoking of an API configured to process a resource.

In some implementations, a user can transmit transaction Tx3 used to create a resource (for example, integrals) of a numeric type to a blockchain. Description will be provided below with integrals as an example. For example, the transaction Tx3 invokes a mint2 function in the above-mentioned contract C1 (with reference to the above-mentioned code example 2). The transaction Tx3 includes input parameters of the mint2 function, such as “Account1, data2, value1”. Account1 is a holder of an integral that is to be created and specified by the user. Data2 is related information of the integral that is to be created. For example, the related information includes a name of the integral. The value1 is the number of integrals that are to be created.

As shown in the code example 2, according to the function mint2, a state variable (also referred to as a resource object) corresponding to the integral that is to be created in the transaction Tx3 is Map3[Account1], and API Pmint2( ) provided by a blockchain platform is invoked. Input parameters of the Pmint2( ) can include Map3, Account1, Account-C1, and value1. Thus, by executing the Pmint2( ), a virtual machine can determine a storage key of the resource object Map3[Account1] based on the Map3, the Account1 and the Account-C1, and store the number of integrals that are to be created corresponding to the storage key. The number can be stored in a balance field of an integral corresponding to the storage key for example.

In some implementations, the input parameters of the mint1 function in the transaction Tx3 further include “tag1” used to indicate a tag (or a type) of an integral that is to be created. For example, the function mint2 can be used to create integrals with different tags. For example, tag1 is set for an integral of a first platform, and tag2 is set for an integral of a second platform. Integrals of resource objects with different tags cannot be transferred to each other, and integrals of resource objects with the same tag can be transferred to each other. In some implementations, the input parameters of the Mint2 function into the Pmint2( ) can further include “tag1”, such that the virtual machine can store a tag of the integral that is to be created through the Pmint2( ).

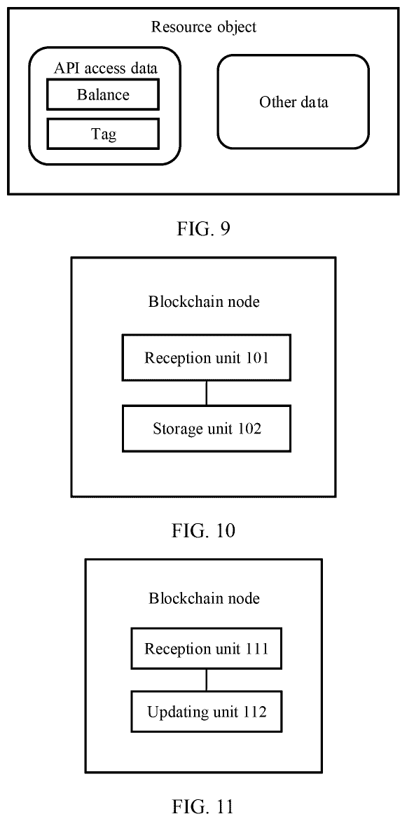

Specifically, FIG. 9 is a schematic diagram illustrating state data of a resource object of a numeric type in embodiments of this specification. As shown in FIG. 9, state data of the resource objects are divided into API access data and other data. The API access data include balance fields and tag fields. In the blockchain platform, the API access data are set to be accessed only by several APIs configured to change the balance of the resource objects. The APIs include, for example, the above-mentioned Pmint2( ), and the interfaces such as Ptransfer2( ) and Pdelete2( ) that will be described below. In this way, in the blockchain, only codes with high security provided by the blockchain platform can be used to perform processing such as balance computation and storage on the resource objects, such that problems such as numerical loss, overflow and data non-conservation can be avoided, and security of resource processing can be improved. Other data in FIG. 9 can be accessed by read-write interfaces provided by contracts through platforms. In a process of executing the above-mentioned transaction Tx3, the virtual machine further stores other related information (that is, data2) of the created integrals through a store function included in the mint2 function.

In some implementations, the user can transmit transaction Tx4 used to transfer integrals to the blockchain. For example, the transaction Tx4 invokes a transfer2 function included in the contract C1. The transaction Tx4 includes input parameters “Account1, Account2, value2” of the transfer2 function. Account1 is an account that transfers integrals out. Account2 is an account that receives the integrals. The value2 is the number of integrals that are to be transferred.

The function transfer2 includes, for example, “Ptransfer2(Map3, Account1, Map4, Account2, Account-C1, value)”. Map3, Account1 and Account-C1 are used to compute a storage key of an integral that is to be transferred out. Map4, Account2 and Account-C1 are used to compute a storage key of an integral that is to be transferred in. Ptransfer2( ) is an API provided by the blockchain platform, and an integral transfer operation is performed between different storage keys through the Ptransfer2( ).

In some implementations, the user can transmit transaction Tx5 used to delete integrals to the blockchain. For example, the transaction Tx5 invokes a Delete function included in the contract C1. The transaction Tx5 includes input parameters “Account1, value3” of the Delete function. Account1 is an account corresponding to an integral that is to be deleted. The value3 is the number of integrals that are to be deleted.

The function Delete includes, for example, “Pdelete(Map3,Account1, Account-C1,value)”. Map3, Account1 and Account-C1 are used to compute a storage key corresponding to the integral that is to be deleted. Pdelete( ) is an API provided by the blockchain platform. The virtual machine performs an integral deletion operation on a target storage key by executing the Pdelete( ).

It can be understood that, in the embodiments of this specification, the storage key corresponding to the resource is determined through the mapping relationship, which does not limit this specification. The storage key corresponding to the resource can be determined in other known ways.

In S820, the blockchain node updates the number of resources corresponding to a target key by executing the API.

For the above-mentioned transaction Tx3, after the blockchain node starts to execute the transaction Tx3, the Pmint2( ) is executed according to invoking of the interface Pmint2( ) in the transaction Tx3. Specifically, the virtual machine in the blockchain node uses Map3, Account1, value1 and Account-C1 as input parameters of the interface Pmint2( ) to execute the interface Pmint2( ). In a process of executing the interface Pmint2( ), the virtual machine determines a storage key key3 (that is, a storage key of the variable Map3[Account1]) of the integral that is to be created based on the Map3, the Account1 and the Account-C1 according to codes in the interface Pmint2( ). Reference can be made to above description for determination of the storage key, which will not be repeated herein. Then, the virtual machine determines whether an integral corresponding to the key3 is stored in the contract state of the contract C1 based on the key3. If the virtual machine determines that the integral corresponding to the key3 is not stored in the contract state of the contract C1, the value1 can be stored in a balance field corresponding to the key3 in the contract state of the contract C1, such that creation of the integral can be completed. If the virtual machine determines that the integral corresponding to the key3 is stored in the contract state of the contract C1, the value1 can be added to the balance of the integral corresponding to the key3. When the virtual machine stores the value1 corresponding to the key3, the value1 is stored in a predetermined data format according to the codes in the interface Pmint2( ), such that numerical loss of integrals can be avoided. When the virtual machine adds the value1 to the integral corresponding to the key3, addition is performed on the integral corresponding to the key3 in a predetermined data format according to the codes in the interface Pmint2( ), such that problems such as numerical loss, overflow and data non-conservation can be avoided.

In some implementations, the input parameters of the Mint2 function into the Pmint2( ) can include “tag1”. When the virtual machine stores the value1 corresponding to the key3 in the contract state of the contract C1, the tag1 can be stored in a tag field corresponding to the key3. In some implementations, the virtual machine determines whether the tag field corresponding to the key3 is tag1 before adding the value1 to the integral corresponding to the key3. If the tag field is the tag1, the value1 is added to the integral corresponding to the key3.

By executing the interface Pmint2( ), the blockchain node can process the number of resources in a predetermined secure way according to codes in the interface Pmint2( ), such that security of resource processing can be improved.

For the above-mentioned transaction Tx4, after the blockchain node starts to execute the transaction Tx4, the Ptransfer2( ) is executed according to invoking of the interface Ptransfer2( ) in the transaction Tx4. Specifically, the virtual machine in the blockchain node uses Map3, Account1, Map4, Account2, Account-C1 and value2 as input parameters of the interface Ptransfer2( ) to execute the interface Ptransfer2( ). In a process of executing the interface Ptransfer2( ), the virtual machine determines a storage key key3 (that is, the storage key of the variable Map3[Account1]) of the integral that is to be transferred and a storage key key4 (that is, the storage key of the variable Map4[Account2]) of the integral that is to be received based on the Map3, the Account1 and the Account-C1 according to codes in the interface Ptransfer2( ). Then, after the virtual machine determines that the number of integrals corresponding to the storage key key3 is greater than the value2, the number of integrals corresponding to the key3 can be reduced by the value2, and the number of integrals corresponding to the key4 can be increased by the value2. In the transfer process, according to the codes in the interface Ptransfer2( ), the virtual machine represents the value2 in a predetermined format. Based on the predetermined format, the number of integrals corresponding to the key3 is reduced by the value2, and the number of integrals corresponding to the key4 is increased by the value2, such that problems such as numerical loss, overflow and data non-conservation can be avoided.

In some implementations, before transferring the integral corresponding to the key3, the virtual machine further reads tag fields corresponding to the key3 and the key4 from the contract state according to the codes in the interface Ptransfer2( ), and determines whether the tag fields corresponding to the key3 and the key4 are consistent. If the tag fields are consistent, the integral of the resource object corresponding to the key3 is transferred to the resource object corresponding to the key4.

In some implementations, the input parameters of the virtual machine into the interface Ptransfer2( ) further include a resource type (for example, an NFT type or an integral type) corresponding to the variable Map3[Account1] and a resource type corresponding to the variable Map4[Account2]. The virtual machine performs the above-mentioned transfer operation of the integrals after determining that the resource type corresponding to the variable Map4[Account2] is consistent with the resource type corresponding to the variable Map3[Account1].

For the above-mentioned transaction Tx5, after the blockchain node starts to execute the transaction Tx5, the Pdelete( ) is executed according to invoking of the interface Pdelete( ) in the transaction Tx5. Specifically, the virtual machine in the blockchain node uses Map3, Account1, Account-C1 and value3 as input parameters of the interface Pdelete( ) to execute the interface Pdelete( ). In a process of executing the interface Pdelete( ), the virtual machine determines the storage key key3 of the integral that is to be deleted based on the Map3, the Account1 and the Account-C1 according to codes in the interface Pdelete( ). Then, if the virtual machine determines that the integral balance corresponding to the storage key key3 is greater than the value3, the integral balance corresponding to the key3 is reduced by the value3. If the virtual machine determines that the integral balance corresponding to the storage key key3 is equal to the value3, all state data corresponding to the key3 are deleted from the contract state, that is, the resource object is deleted. In the process of integral deletion, the virtual machine represents the value3 in a predetermined format according to the codes in the interface Pdelete( ), and reduces the integral balance corresponding to the key3 by the value3 based on the predetermined format, such that problems such as numerical loss, overflow and data non-conservation can be avoided.

FIG. 10 is a structural diagram illustrating a blockchain node in embodiments of this specification. The blockchain node includes the following: a reception unit 101 configured to receive a first transaction, where the first transaction invokes a contract, the contract includes invoking of a first interface, and the first interface is provided by a blockchain platform; and a storage unit 102 configured to execute the first interface according to the first transaction, determine whether a resource corresponding to a first storage key is stored in a contract state of the contract, and store a first NFT resource in the contract state in association with the first storage key if the resource corresponding to the first storage key is not stored in the contract state of the contract.

FIG. 11 is a structural diagram illustrating a blockchain node in embodiments of this specification. The blockchain node includes the following: a reception unit 111 configured to receive a second transaction, where the second transaction invokes a contract, the contract includes invoking of a second interface, and the second interface is provided by a blockchain platform; and an updating unit 112 configured to execute the second interface according to the second transaction, and update the balance of a first resource corresponding to a third storage key in a contract state of the contract.

The embodiments of this specification further provide computer-readable storage media. The computer-readable storage medium stores a computer program. When the computer program is executed in a computer, the computer is caused to execute the method shown in FIG. 7 or FIG. 8.

The embodiments of this specification further provide blockchain nodes. The blockchain node includes a memory and a processor. The memory stores executable code. When the processor executes the executable codes, the method shown in FIG. 7 or FIG. 8 is implemented.

In the 1990s, whether a technical improvement is a hardware improvement (for example, an improvement to a circuit structure such as a diode, a transistor, or a switch) or a software improvement (an improvement to a method flow) can be clearly distinguished. However, with the development of technology, improvements to many method flows can be regarded as direct improvements to hardware circuit structures. Almost all designers obtain corresponding hardware circuit structures by programming improved method flows into hardware circuits. Thus, improvements to a method flow can be implemented through hardware entity modules. For example, a programmable logic device (PLD), such as a field programmable gate array (FPGA), is such an integrated circuit whose logic functions are determined through device programming by users. The designers perform programming to “integrate” a digital system to a PLD without requesting a chip manufacturer to design and produce an application-specific integrated circuit chip. Moreover, now, instead of manually making an integrated circuit chip, this programming is mostly executed with “logic compiler” software, which is similar to a software compiler used when the program is developed, and the original code before it is compiled also has to be written in a specific programming language, which is referred to as Hardware Description Language (HDL), and there is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. It should be clear to a person skilled in the art that a hardware circuit that implements a logical method flow can be readily obtained once the method flow is logically programmed through the above-mentioned several hardware description languages and is programmed into an integrated circuit.

Controllers can be implemented through any appropriate method. For example, the controllers can be microprocessors or processors, or computer-readable media that store computer readable program codes (such as software or firmware) that can be executed by the microprocessors or the processors, logic gates, switches, application specific integrated circuits (ASICs), programmable logic controllers, or embedded microprocessors. Examples of the controllers include, but are not limited to, the following microprocessors: ARC 625D, Atmel AT91SAM, Microchip PIC18F26K20, and Silicon Labs C8051F320. The memory controllers can also be implemented as part of control logics of memories. A person skilled in the art also knows that in addition to implementing the controllers through only the computer-readable program codes, logic programming can be performed on method steps to enable the controllers to implement the same function in a form of logic gates, switches, application specific integrated circuits, programmable logic controllers, embedded microcontrollers, etc. Thus, the controller can be considered to be a hardware component, while an apparatus included in the controller and used to implement various functions can also be considered as a structure in the hardware component. Or, the apparatus for implementing various functions can even be considered as both a software module for implementing a method and the structure in the hardware component.

The system, apparatus, module, or unit stated in the above-mentioned embodiments can specifically be implemented by a computer chip or entity, or can be implemented by a product having a certain function. A typical implementing device is a server system. Clearly, this application does not exclude that with development of future computer technologies, computers that implement functions of the above-mentioned embodiments can be, for example, personal computers, laptop computers, vehicular man-machine interaction devices, cellular phones, camera phones, smart phones, personal digital assistants, media players, navigation devices, e-mail devices, game consoles, tablet computers, wearable devices, or any their combinations.

Although one or more embodiments of this specification provide method operating steps as described in the embodiments or flowcharts, more or fewer operating steps can be included on the basis of conventional or noncreative means. The order of steps enumerated in the embodiments is only one of many step execution orders and does not represent a unique order of execution. During execution in actual apparatuses or end products, execution can be performed sequentially or in parallel in the method order shown in the embodiments or the accompanying drawings (for example, through parallel processors or multithreaded processing environments, or even distributed data processing environments). The terms such as “include”, “comprise” or any other their variations are intended to cover non-exclusive inclusion, such that processes, methods, products, or devices including a series of elements include not only the elements but also other elements not explicitly listed, or elements inherent to such processes, methods, products, or devices. Without further limitations, existence of additional same or equivalent elements in the processes, methods, products or devices including the elements is not excluded. For example, if the words such as first and second are used for indicating names, the words do not indicate any particular order.

For convenience of description, the above-mentioned apparatuses are divided into various modules according to functions for respective descriptions. Clearly, during implementation of one or more embodiments of this specification, the functions of the modules can be implemented in the same one or more pieces of software and/or hardware, or modules implementing the same function can be implemented through a combination of a plurality of sub-modules or sub-units, etc. The above-mentioned apparatus embodiments are merely schematic, for example, division of units is merely logical function division. In actual implementation, there are other modes of division. For example, a plurality of units or components can be combined or can be integrated into another system, or some features can be omitted, or not executed. In addition, the displayed or discussed mutual couplings or direct couplings or communication connections can be implemented through some interfaces. Indirect couplings or communication connections between apparatuses or units can be implemented in electronic, mechanical, or other forms.

This application is described with reference to the flowchart and/or block charts of methods, apparatuses (systems), and computer program products according to the embodiments of this application. It should be understood that each flow and/or block in flowcharts and/or block charts, and combinations of flows and/or blocks in the flowcharts and/or the block charts, can be implemented by computer program instructions. The computer program instructions can be provided for a general-purpose computer, a special-purpose computer, an embedded processor, or a processor of another programmable data processing device to generate a machine, such that instructions executed by the computer or the processor of the another programmable data processing device generate an apparatus for implementing a specific function in one or more flows in the flowcharts and/or in one or more blocks in the block charts.

Alternatively, the computer program instructions can be stored in a computer-readable memory that can instruct a computer or another programmable data processing device to work in a specific way, such that the instructions stored in the computer-readable memory generate an artifact that includes an instruction apparatus. The instruction apparatus implements a specific function in one or more flows in the flowcharts and/or in one or more blocks in the block charts.

Alternatively, the computer program instructions can be loaded onto a computer or another programmable data processing device, such that a series of operating steps are performed on the computer or another programmable device, to generate computer-implemented processing. Thus, the instructions executed on the computer or another programmable device provide steps for implementing a specific function in one or more flows in the flowcharts and/or in one or more blocks in the block charts.

The computer-readable media are nonvolatile, volatile, removable and non-removable media that can store information through any method or technology. The information can be computer-readable instructions, data structures, program modules, or other data. Examples of the computer storage media include, but are not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a read-only optical disc read-only memory (CD-ROM), a digital versatile disc (DVD) or other optical memories, a magnetic cassette, a magnetic tape or disk memory, a graphene memory or other magnetic storage devices, or any other non-transmission media that can be used to store information that can be accessed by computing devices. Based on the definition herein, the computer-readable media do not include transitory media such as modulated data signals and carriers.

A person skilled in the art should understand that one or more embodiments of this specification can be provided as methods, systems, or computer program products. Thus, one or more embodiments of this specification can use forms of fully hardware embodiments, fully software embodiments, or embodiments combining software and hardware aspects. Moreover, one or more embodiments of this specification can use a form of computer program products implemented on one or more computer available storage media (including, but not limited to, disk memories, CD-ROMs, optical memories, etc.) including computer available program codes.

One or more embodiments of this specification can be described in the general context, such as program modules, of computer-executable instructions executed by computers. Generally, the program modules include routines, programs, objects, components, data structures, etc. for executing specific tasks or implementing specific abstract data types. One or more embodiments of this specification can be practiced in distributed computing environments. In the distributed computing environments, tasks are executed by remote processing devices that are connected through communication networks. In the distributed computing environments, the program modules can be located in both local and remote computer storage media including storage devices.

All the embodiments of this specification are described in a progressive way. Reference can be made mutually for the same or similar parts of the embodiments. All the embodiments focus on differences from other embodiments. Particularly, system embodiments are basically similar to method embodiments, and are described briefly. Reference can be made to some description in the method embodiments for related parts. In the description of this specification, reference to terms such as “embodiments”, “some embodiments”, “examples”, “specific examples”, or “some examples” means that specific features, structures, materials, or characteristics described in conjunction with the embodiments or examples are included in at least one of the embodiments or examples of this specification. In this specification, illustrative expressions of the above-mentioned terms do not necessarily refer to the same embodiments or examples. Moreover, the described specific features, structures, materials, or characteristics can be combined in any suitable manner in any one or more embodiments or examples. In addition, a person skilled in the art can combine and associate different embodiments or examples and features of different embodiments or examples described in this specification without any conflicts between the embodiments or examples and the features of the embodiments or examples.

What are described above are merely embodiments of one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification should fall within the scope of the claims.

1. A method for processing resources by a blockchain node in a blockchain, comprising:
receiving a transaction, wherein the transaction invokes a contract to invoke a interface provided by a blockchain platform;
execute the interface based on the transaction;
determining whether a resource corresponding to a first storage key is stored in a contract state of the contract; and
storing a first non-fungible token (NFT) resource in the contract state in association with the first storage key if the resource corresponding to the first storage key is not stored in the contract state of the contract.

2. The method according to claim 1, wherein the interface comprises a creation interface configured to create an NFT resource, wherein input parameters to the creation interface comprise a first identifier of a first mapping relationship, a first account, and a contract address of the contract, and wherein the method further comprises:
determining the first storage key based on the first identifier, the first account, and the contract address of the contract.

3. The method according to claim 1, wherein the interface comprises a transfer interface configured to transfer an NFT resource, wherein input parameters to the transfer interface comprise a first identifier of a first mapping relationship, a first account, a second identifier of a second mapping relationship, a second account, and a contract address of the contract, and the method further comprises:
determining the first storage key based on the first identifier, the first account, and the contract address of the contract;
determining a second storage key based on the second identifier, the second account, and the contract address of the contract; and
reading the first NFT resource from the contract state based on the second storage key.

4. The method according to claim 3, wherein the input parameters further comprise a first resource type corresponding to the first storage key and a second resource type corresponding to the second storage key, and the determining whether a resource corresponding to a first storage key is stored in a contract state of the contract comprises:
determining whether the first resource type is consistent with the second resource type; and
determining whether a resource corresponding to a first resource object is stored in the contract state of the contract when the first resource type is consistent with the second resource type.

5. The method according to claim 4, wherein the determining whether a resource corresponding to a first storage key is stored in a contract state of the contract comprises:
determining the first storage key based on the first identifier, the first account, the contract address of the contract, and the first resource type; and
determining whether the resource corresponding to the first storage key is stored in the contract state.

6. A method for processing resources performed by a blockchain node in a blockchain, comprising:
receiving a transaction, wherein the transaction invokes a contract to invoke an interface provided by a blockchain platform;
executing the interface based on the transaction; and
updating a balance of a resource corresponding to a storage key in a contract state of the contract.

7. The method according to claim 6, wherein the interface comprises a creation interface configured to create a resource, wherein input parameters to the creation interface comprise a first identifier of a first mapping relationship, a first account, a first number of the resource, and a contract address of the contract, and wherein the balance of the resource corresponding to the storage key is updated by executing the interface based on the transaction by performing:
executing the interface according to the transaction;
determining the storage key based on the first identifier, the first account, and the contract address of the contract; and
updating the balance of the resource corresponding to the storage key in the contract state of the contract.

8. The method according to claim 7, wherein the input parameters to the creation interface further comprise a resource tag of the resource, and wherein the method further comprises:
storing the resource tag of the resource corresponding to the storage key in the contract state of the contract.

9. The method according to claim 8, wherein the interface further comprises a transfer interface configured to transfer a resource, wherein input parameters to the transfer interface comprise a first identifier of a first mapping relationship, a first account, a second identifier of a second mapping relationship, a second account, a second number of the resource to be transferred, and a contract address of the contract, and wherein the balance of the resource corresponding to the storage key is updated by executing the interface based on the transaction by performing:
determining the storage key based on the first identifier, the first account and the contract address of the contract, and determining a second storage key based on the second identifier, the second account, and the contract address of the contract; and
reducing the balance of the resource corresponding to the storage key by the second number, and increasing the balance of the resource corresponding to the second storage key by the second number.

10. The method according to claim 9, wherein the input parameters to the transfer interface further comprise a first asset type corresponding to a first storage key and a second asset type corresponding to the second storage key, and the determining the first storage key and the second storage key comprises:
determining the first storage key based on the first identifier, the first account, the contract address of the contract and the first asset type; and
determining the second storage key based on the second identifier, the second account, the contract address of the contract and the second asset type in response to determining that the first asset type is consistent with the second asset type.

11. The method according to claim 9, wherein the reducing and increasing the balance of the resource comprise:
obtaining a first resource tag corresponding to a first storage key and a second resource tag corresponding to the second storage key in the contract state; and
reducing the balance of the resource corresponding to the first storage key by the second number and increasing the balance of the first resource corresponding to the second storage key by the second number when the first resource tag is consistent with the second resource tag.

12. A blockchain node, comprising:
at least one processor; and
one or more memories coupled to the at least one processor and storing programming instructions for execution by the at least one processor to perform operations comprising:
receiving a transaction, wherein the transaction invokes a contract to invoke a first interface provided by a blockchain platform;
execute the first interface based on the transaction;
determining whether a resource corresponding to a first storage key is stored in a contract state of the contract; and
storing a first non-fungible token (NFT) resource in the contract state in association with the first storage key if the resource corresponding to the first storage key is not stored in the contract state of the contract.

13. The blockchain node according to claim 12, wherein the first interface comprises a creation interface configured to create an NFT resource, wherein input parameters to the creation interface comprise a first identifier of a first mapping relationship, a first account, and a contract address of the contract, and wherein the operations further comprise:
determining the first storage key based on the first identifier, the first account, and the contract address of the contract.

14. The blockchain node according to claim 12, wherein the first interface comprises a transfer interface configured to transfer an NFT resource, wherein input parameters to the transfer interface comprise a first identifier of a first mapping relationship, a first account, a second identifier of a second mapping relationship, a second account, and a contract address of the contract, and the operations further comprise:
determining the first storage key based on the first identifier, the first account, and the contract address of the contract;
determining a second storage key based on the second identifier, the second account, and the contract address of the contract; and
reading the first NFT resource from the contract state based on the second storage key.

15. The blockchain node according to claim 14, wherein the input parameters further comprise a first resource type corresponding to the first storage key and a second resource type corresponding to the second storage key, and the determining whether a resource corresponding to a first storage key is stored in a contract state of the contract comprises:
determining whether the first resource type is consistent with the second resource type; and
determining whether a resource corresponding to a first resource object is stored in the contract state of the contract when the first resource type is consistent with the second resource type.

16. The blockchain node according to claim 15, wherein the determining whether a resource corresponding to a first storage key is stored in a contract state of the contract comprises:
determining the first storage key based on the first identifier, the first account, the contract address of the contract, and the first resource type; and
determining whether the resource corresponding to the first storage key is stored in the contract state.
